(19) United States
(12) Patent Application Publication
(10) Pub. No.: US 2022/0088548 A1
(43) Pub. Date: Mar. 24, 2022

(54) AGITATOR FOR BEVERAGE CONTAINERS

(71) Applicant: BrewLogix LLC, Indianapolis, IN (US)

(72) Inventor: Robert B. Eveleigh, Naples, FL (US)

(73) Assignee: BrewLogix LLC, Indianapolis, IN (US)

(21) Appl. No.: 17/448,772

(22) Filed: Sep. 24, 2021

Related U.S. Application Data
(60) Provisional application No. 63/198,019, filed on Sep. 24, 2020.

(51) Int. Cl. B01F 9/00; B65D 21/02; B01F 9/10; B01F 15/00

(52) U.S. Cl. CPC B01F 9/003; B65D 21/0224; B01F 9/10; B01F 2015/0011; B01F 2009/0083; B01F 2215/007; B01F 15/00194

(57) ABSTRACT

Various embodiments disclosed herein pertain to methods and apparatus for agitation of stored beverage containers to enhance the flavor of the beverage. Embodiments disclosed herein include devices that permit rotation of a beverage container supported by a weight sensor, and also rotation of one or more beverage containers in a stack. Also disclosed are devices for pivoting a container back and forth to create internal sloshing. Also disclosed are devices that permit agitation of a smaller beverage container stacked on top of a larger beverage container.

### CROSS REFERENCE TO RELATED APPLICATION

This application claims the benefit of priority to U.S. Provisional Patent Application Ser. No. 63/198,019, filed Sep. 24, 2020, incorporated herein by reference.

### FIELD OF THE INVENTION

Various embodiments of the present inventions pertain to methods and apparatus for supporting a beverage container, and including embodiments in which the supported container can be agitated.

### SUMMARY OF THE INVENTION

One aspect of the present invention pertains to an apparatus for supporting a beverage container. Some embodiments include a weight sensor for measuring the weight of a beverage container and a top platter adapted and configured for supporting said weight sensor. Still other embodiments include a bottom platter rotatably supporting the top platter for rotation of the beverage container about the axis, the bottom platter including means for coupling the bottom platter to the top of a beverage container.

Another aspect of the present invention pertains to an apparatus for supporting a beverage container. Some embodiments include a weight sensor assembly for measuring the weight of a beverage container including a plurality of measurement. Yet other embodiments include a first plurality of rotatable bearings. Still other embodiments include a first platter adapted and configured for supporting the bottom of the beverage container with the plurality of rotatable bearings, and a bottom surface, the bottom surface being adapted and configured to transfer the weight of the beverage container to the measurement stations.

Yet another aspect of the present invention pertains to an apparatus for stacking of beverage containers. Other embodiments include a top platter adapted and configured for supporting the weight of the top beverage container. Yet other embodiments include a bottom platter and rotatably supporting the bottom of the top platter, the bottom platter including a bottom wall for mounting the bottom platter to the top of a bottom beverage container. Still other embodiments include a plurality of rotatable bearings located between the top platter and the bottom platter.

Still another aspect of the present invention pertains to an apparatus for stacking of beverage containers, including a top platter adapted and configured for contacting the bottom of a top beverage container and supporting the weight of the top beverage container, the top beverage container having a longitudinal axis. Yet other embodiments include a bottom platter having a bearing surface for rotatably supporting the bottom of the top platter, the bottom platter including a bottom wall extending along at least a portion of the periphery for mounting the bottom platter to the bottom beverage container. Still other embodiments include a first plurality of rotatable bearings, the first plurality of bearings transferring the weight from the top platter to the bottom platter; wherein the shape of the bearing surface is adapted and configured to permit rotation of the top beverage container relative to the bottom beverage container along a rotational axis that is at least partly orthogonal to the longitudinal axis.

Further still, another aspect of the present invention pertains to an apparatus for stacking of beverage containers including a top platter having a top surface the top beverage container having a longitudinal axis, and a bottom surface. Yet other embodiments include a platter assembly adapted and configured for contacting the bottom of a top beverage container and the top of a bottom beverage container and for supporting the weight of the top beverage container, and including means for mounting the platter to the top of a bottom beverage container and means for limiting the lateral movement of the top beverage container when the top beverage container is located on the platter. Still other embodiments include a first plurality of bearings spaced circumferentially around the platter and each at a location adapted and configured for contact with the top of the bottom beverage container and for transferring the weight of the top beverage container to the bottom beverage container.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may have been created from scaled drawings, scaled models, or from photographs that are scalable. It is understood that such dimensions, or the relative scaling within a figure, are by way of example, and not to be construed as limiting unless so stated in a claim.

FIG. 1 is a side elevational view of a pair of beverage containers according to the prior art.

FIG. 2 is a side elevational view of a pair of beverage containers, each supported by a weight sensor and an agitating apparatus according to various embodiments of the present invention.

FIG. 3 is a side elevational view of a pair of stacked beverage containers, each supported by a container agitating apparatus according to various embodiments of the present invention.

FIG. 4 is a close-up, partly cross sectional, side elevational view of two of the containers of FIG. 2 and the weight sensor and container agitator therebetween.

FIG. 5 is a side elevational, cross sectional view of the portion of the apparatus of FIG. 4.

FIG. 6A is a top plan view of a portion of the apparatus of FIG. 5.

FIG. 6B is a cross sectional view of the apparatus of FIG. 6A, as taken along line 6B-6B.

FIG. 7A is a top plan view of a portion of the apparatus of FIG. 5.

FIG. 7B is a cross section view of the apparatus of FIG. 7A, as taken along line 7B-7B.

FIG. 8 is a close-up, partly cross sectional, side elevational view of the bottom container of FIG. 2 and the weight sensor and container agitator supporting each of the beverage containers.

FIG. 9A is a close-up, top, perspective representation of a bearing assembly according to one embodiment of the present invention.

FIG. 9B is a partial cross sectional view of the container agitator of FIG. 8.

FIG. 10A is a top plan view of a portion of the apparatus of FIG. 9B.

FIG. 10B is a cross sectional view of FIG. 10A, as taken along line 10B-10B.

FIG. 11A is a top plan view of a portion of the apparatus of FIG. 9B.

FIG. 11B is a cross sectional view of the apparatus of FIG. 11A, as taken along line 11B-11B.

FIG. 12A is a top plan view of an alternative to the apparatus of FIG. 10A.

FIG. 12B is a cross sectional view of the apparatus of FIG. 12A, as taken along line 12B-12B.

FIG. 13 is a side elevational, partial cross sectional representation of the container agitating apparatus located at the bottom of container 10D of FIG. 3.

FIG. 14A is a cross sectional representation of a portion of the apparatus of FIG. 13.

FIG. 14B is a cross sectional view of the apparatus of FIG. 14A, as taken along line 14B-14B.

FIG. 15 is a partial cross sectional view of the container agitating apparatus located between beverage containers 10c and 10d of FIG. 3.

FIG. 16 is a close-up, partly cross sectional, side elevational view of an alternative container agitator, shown located between containers 10c and 10d of FIG. 3.

FIG. 17 is a close-up, partly cross sectional, side elevational view of the container agitating apparatus of FIG. 16, shown between beverage container 10d on the bottom, and a smaller diameter beverage container 10e on top.

### ELEMENT NUMBERING

The following is a list of element numbers used with all of the embodiments, and at least one noun used to describe that element. The “X” for all of these numbers is removed or replaced with a number (0 or greater) in the text and drawings of this application. Consistent with statements made elsewhere in this specification, these various 2-digit element numbers are used among multiple embodiments, and aspects of a particular element stated for one embodiment can be applied to the same element number in a different embodiment, except as shown and described differently, and as would be understood by a person of ordinary skill in the art. It is understood that none of the embodiments disclosed herein are limited to these nouns, and these element numbers can further include other words that would be understood by a person of ordinary skill reading and reviewing this disclosure in its entirety.

| | | | |
|---|---|---|---|
| 10 | beverage container | .2 | central aperture |
| 12 | top surface | .3 | gusset |
| .1 | rolled edge | X44 | means for limiting lateral |
| | | | movement of keg |
| | | | or sensor; means for |
| | | | mounting to keg or sensor |
| 14 | bottom surface | .1 | upwardly extending wall |
| .1 | rolled edge | .2 | downwardly extending wall |
| 16 | pressure vessel | .3 | spring clips |
| .1 | internal volume | .4 | rocking motion abutments |
| .2 | centroid | X46 | transducer contacting |
| | | | surface |
| .3 | central rotational axis | X48 | bearing pocket or aperture |
| .4 | lateral (rocking) rotation axis | X49 | bearing contact surface |
| X20 | container agitating and | X50 | first bearing assembly |
| | supporting apparatus | | |
| X21 | rotational axis | .1 | rotatable bearing |
| X30 | weight sensor assembly | .2 | bearing holder |
| X32 | transducer | .3 | axle |
| .1 | top surface | X52 | second bearing assembly |
| X40 | first platter | .1 | rotatable bearing |
| X42 | body | .2 | bearing holder |
| .1 | peripheral edge | .3 | axle |
| X56 | interplatter connection | | of keg or sensor; means for |
| | | | mounting to keg or sensor |
| X60 | second platter | .1 | upwardly extending wall |
| X62 | body | .2 | downwardly extending wall |
| .1 | peripheral edge | .3 | spring clips |
| .2 | central aperture | X66 | transducer contacting |
| | | | surface |
| .3 | gusset | X69 | bearing contact surface |
| .4 | abutment | | |
| X64 | means for limiting | | |
| | lateral movement | | |

### DETAILED DESCRIPTION OF ONE OR MORE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention, and further permits the reasonable and logical inference of still other embodiments as would be understood by persons of ordinary skill in the art.

It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “various embodiments” or “preferably,” refers to features and aspects that are present in at least one embodiment, but which are optional for some embodiments, it therefore being understood that use of the word “preferably” implies the term “optional.”.

The use of an N-series prefix for an element number (NYY.YY) refers to an element that is the same as the non-prefixed element (YY.YY), except as shown and described. As an example, an element 1020.1 would be the same as element 20.1, except for those different features of element 1020.1 shown and described. Further, common elements and common features of related elements may be drawn in the same manner in different figures, and/or use the same symbology in different figures. As such, it is not necessary to describe the features of 1020.1 and 20.1 that are the same, since these common features are apparent to a person of ordinary skill in the related field of technology. Further, it is understood that some features 1020.1 and 20.1 may be backward compatible, such that a feature of a later discussed embodiment (NYY.YY) may include features compatible with other various embodiments that were discussed earlier (MYY.YY), as would be understood by those of ordinary skill in the art. This description convention also applies to the use of prime (′), double prime (″), triple prime (′″) and star or asterisk (*) suffixed element numbers. Therefore, it is not necessary to describe the features of 20.1, 20.1′, 20.1″, 20.1′″ and 20* that are the same, since these common features are apparent to persons of ordinary skill in the related field of technology.

This document may use different words to describe the same element number, or to refer to an element number in a specific family of features (NYY.YY). It is understood that such multiple, different words are not intended to provide a redefinition of any language herein. It is understood that such words demonstrate that the particular feature can be considered in various linguistical ways, such ways not necessarily being additive or exclusive.

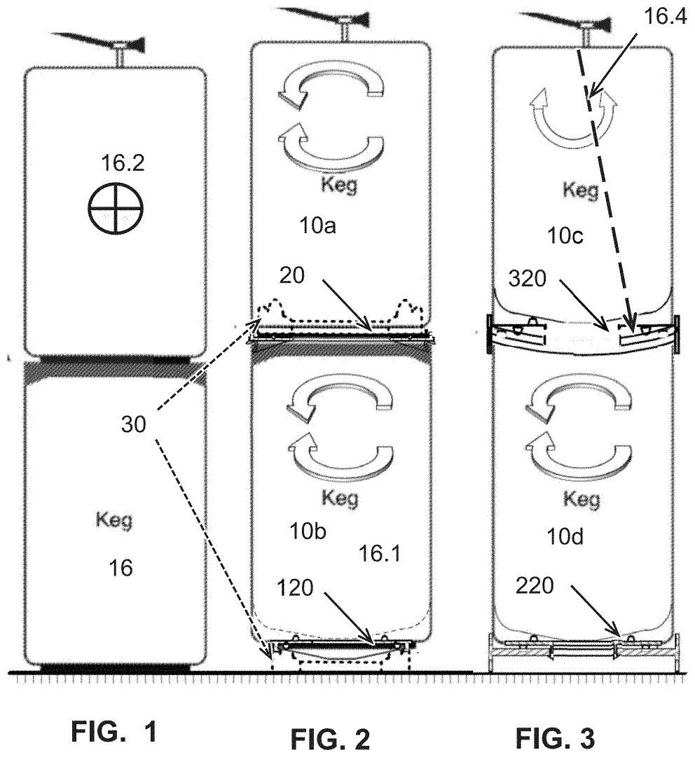

FIGS. 1, 2, and 3 each show a pair of beverage containers, with one container stacked on top of the other. FIG. 1 shows a pair of containers 10, with a top container stacked on top of the bottom container by prior art methods. The top container indicates an approximate location for a centroid 16.2 of the internal volume 16.1 of the container pressure vessel 16. Neither of the containers of FIG. 1 are supported by a weight sensor, and each of the containers are supported such that any rotation of the container is difficult, with a need to overcome substantial friction.

FIG. 2 shows a pair of beverage containers 10a and 10b, each supported by a weight sensor 30, and each being supported by a corresponding agitation apparatus 20 and 120, respectively. FIG. 3 shows a pair of beverage containers 10c and 10d, with each of the containers being supported by a corresponding agitation apparatus 320 or 220, respectively.

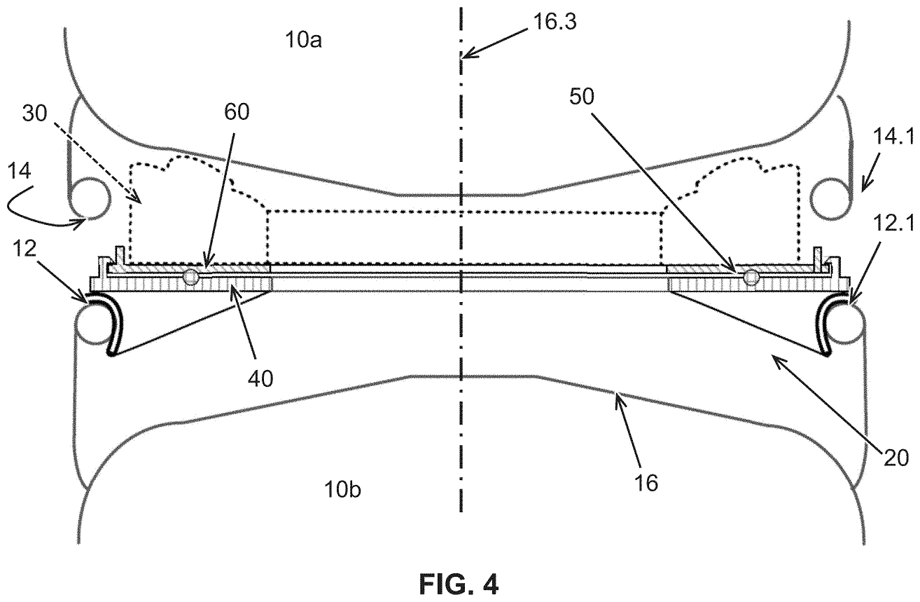

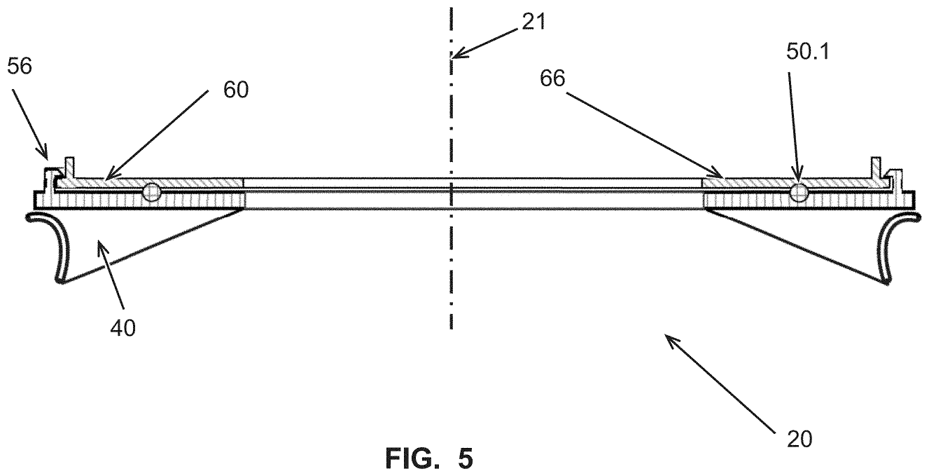

FIG. 4 is a close-up, partly cutaway, side elevational view of the interface of containers 10a and 10b of FIG. 2. For the particular containers 10a and 10b shown, each has a circumferentially extending rolled edge 14.1 or 12.1, respectively. In these particular containers, these rolled edges also define the respective top surface 12 or bottom surface 14, respectively. In some embodiments, the agitation apparatus shown herein support containers 10 having an internal pressure vessel 16, especially for beverages such as beer. However, in yet other containers the beverage is contained within a nonpressurized vessel, which may alternatively be a thermally insulated container (such as for coffee), and/or a food-safe container (for any beverage, such as kombucha, tea, etc.).

FIGS. 4 to 7 show that a beverage container agitation apparatus 20 in one embodiment is supported on the top surface 12 of a beverage container, and in some embodiments this interface between the agitating apparatus 20 and the container 10 is substantially a static interface. A weight sensor assembly 30 is shown in dotted outline, and resting on top of a transducer contacting surface 66. In some embodiments, the weight sensor 30 is in contact with the underside of the beverage containing vessel 16, and largely not in contact with other surfaces of the container 10a, so as to not alter the amount of the weight supported by sensor 30. It can be seen that in one embodiment sensor 30 fits within the inner diameter of the rolled edge 14.1.

FIGS. 5, 6, and 7 show additional views of container agitation apparatus 20. Referring to FIG. 5, apparatus 20 includes a first, lower platter 40 and a second, top platter 60, with an interface of a bearing assembly 50 therebetween. Platter 60 is substantially free to rotate about the top of lower platter 40. Preferably, the assembly of platters 40 and 60 is adapted and configured such that rotation of platter 60 about platter 40 is substantially the same as rotation about the longitudinal axis 16.3 of pressure vessel 16. However, various other embodiments of the present inventions contemplate container agitation assemblies in which the rotational axis of one of the platters is offset from the longitudinal axis of the container, which may enhance the agitation of the beverage within the container. In such embodiments, the rotational axis 21 of one of the platters is laterally offset from the centerline of the container, and in still further embodiments the axes 16.3 and 21 can also be non-parallel or angularly offset.

Referring to FIG. 5, it can be seen that the top and bottom platters 60 and 40 include an interplatter connection 56 that prevents substantial lateral movement of one platter relative to another, and preferably prevents axial separation of one platter from another, yet at the same time permits substantially free rotation of one platter relative to another. Referring to FIG. 5, it can be seen that the top platter 60 includes a short, upwardly depending wall surrounded by a short, circumferential ledge. The upwardly depending wall provides a means for limiting the lateral separation of the weight sensor from the apparatus 20. This ledge of platter 60 fits within a groove of an upwardly depending wall of bottom platter 40. As best seen in FIG. 5, the upwardly depending wall of platter 40 preferably includes in some embodiments an angled surface that permits a securement of the top platter within the groove of the bottom platter by simply pressing the two platters together with the angled surface resulting in a temporary outside bending of the upwardly depending wall. However, it is contemplated that the top and bottom platters can be interconnected in any manner which limits the relative lateral movement, limits the relative longitudinal movement, but substantially does not inhibit the relative rotational movement of the platters relative to each other.

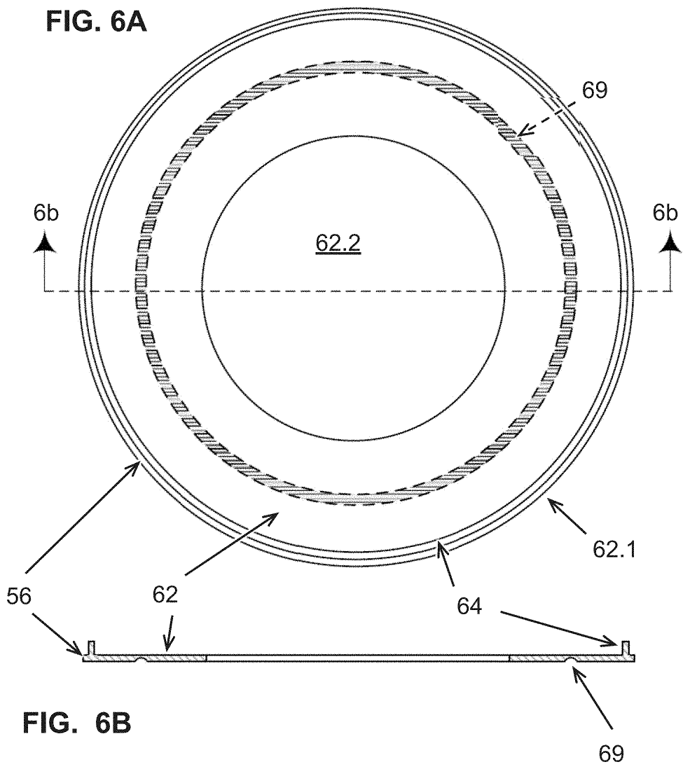

FIGS. 6A and 6B show top and side cross sectional views, respectively, of the top platter 60 of apparatus 20. It can be seen that platter 60 preferably includes a central aperture 62.2 that is sized to avoid structural interference with the beverage container. The top surface 66 of platter 60 is preferably adapted and configured to maintain an even and consistent contact with the weight sensor 30. As shown, top surface 66 is substantially planar, but other embodiments contemplate platter top surfaces that are especially adapted for particular kinds of contact with the weight sensor, including as by example a platter top surface that interlocks to the bottom of a weight sensor assembly so as to inhibit relative rotational movement of the sensor relative to platter 60.

Platters 60 and 40 each include an interface adapted and configured for contact with a bearing assembly 50, and to permit one platter to rotate relative to the other platter. Referring to FIG. 6B, it can be seen that the underside of platter 60 includes a bearing contact surface 69 that is preferably a smooth, rounded groove that extends circumferentially within the platter body 62. The radius of this circumferential contact surface 69 is selected to be about the same as the radial location of the separate rotatable bearings 50.1 (these bearings best seen in FIG. 5).

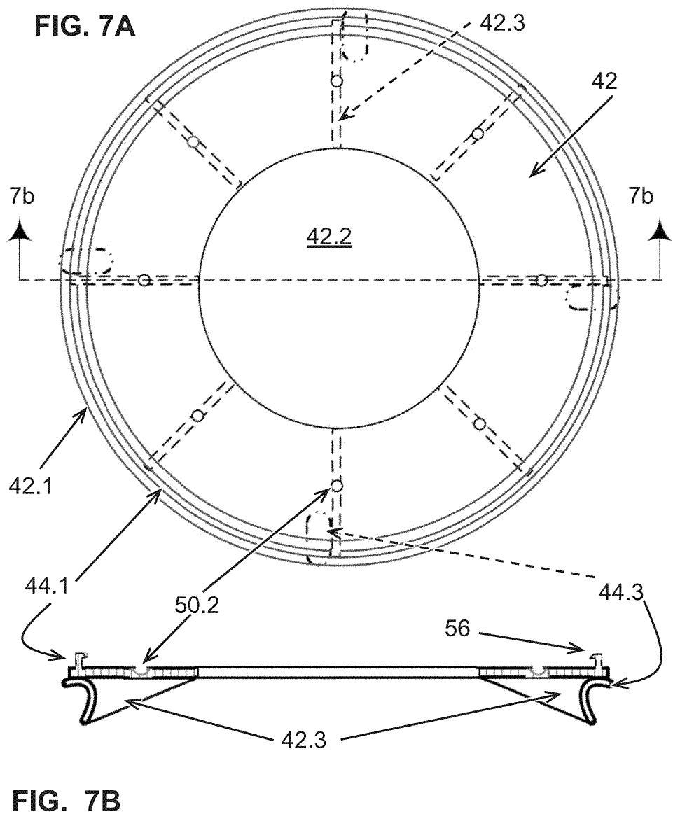

Referring now to FIGS. 7A and 7B, it can be seen that these bearings 50.1 are each received within a respective bearing holder 50.2. FIG. 7A shows an array of bearing holders 50.2 that are equally spaced at the same radial location as bearing contact surface 69. Therefore, these bearings 50.1 remain located within their respective holders 50.2, but traverse anywhere within contact surface 69 as the platters are rotated. Although what is shown and described are ball bearings 50.1 rotatably held in place on the bottom platter, it is understood that yet other embodiments contemplate any other type of rotatable bearing (such as cylindrical roller and tapered roller, as examples), and further those embodiments in which the rotatable bearings are supported at locations on the top platter. In still further embodiments, the bearings can be interconnected by a separate spacer assembly (similar in concept to a spacer used with some types of ball bearing assemblies), with this separate spacer assembly of bearings being located between top and bottom platters.

Referring to FIGS. 7A and 7B, it can be seen that the bottom platter 40 likewise includes a central aperture 42.2 adapted and configured to avoid interference with the beverage container. In the embodiment shown, each of the bearing holders 50.2 is generally aligned with a strengthening gusset 42.3 that extends from the outer diameter of the central aperture to the outer edge of the platter. These gussets strengthen the body 42 and reduce bending from the load of the container 10a. In some embodiments, platter 40 further includes one or more spring clips 44.3 that can be spaced around the periphery 42.1 of body 42. In some embodiments, these spring clips 44.3 provide a snap on attachment of assembly 20 onto the beverage container 10b. These clips 44.3 further provide means 44 for limiting lateral movement of the platter assembly relative to the container 10b.

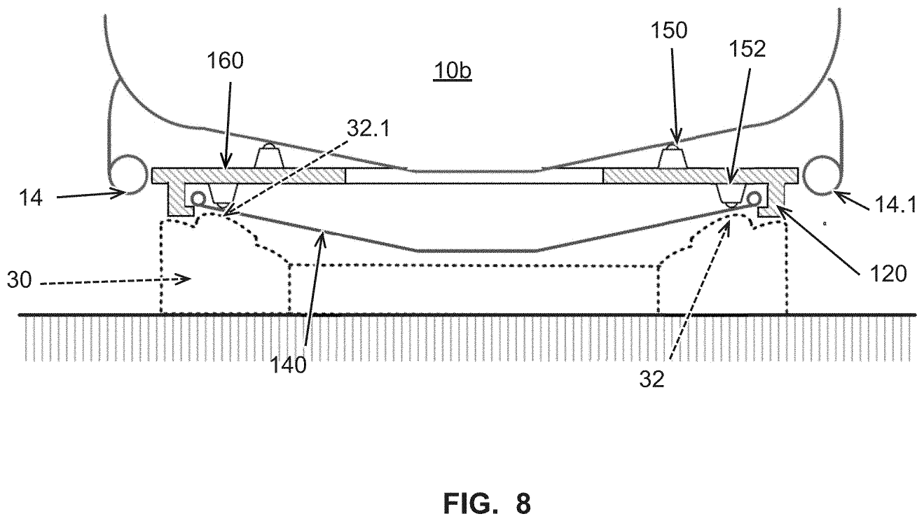

FIGS. 8-12 depict various aspects of a container agitation assembly 120 according to another embodiment of the present invention. FIG. 8 shows a weight sensor assembly 30 (dotted lines) resting on a surface. A container agitation apparatus 120 is located on top of sensor assembly 30, and is adapted and configured to support a beverage container 10b located above, and to transmit the weight of the beverage container to the sensor apparatus. It can be seen that the container 10b in some embodiments has an empty compartment on the bottom, such that apparatus 120 can fit within this open volume. Top platter 160 of assembly 120 includes one or more bearing assemblies 150 that contact the underside of the beverage pressure vessel 16. However, it is understood that in yet other embodiments the top bearing assembly can contact any portion of the container 10b, including the bottom surface 14 of the rolled edges 14.1, or in any other manner such that the supported weight is accurately transferred through assembly 120 and into the weight sensor.

FIG. 8 further shows a bottom platter 140 that provides a flexible, weight transferring interface from bottom bearing assembly 152 into the top surface 32.1 of the separate transducers 32 of sensor assembly 30. Apparatus 120 takes into account that the sensor assembly 30 in some embodiments has a plurality of circumferentially arranged, separate weight sensors 32. Each of these weight sensors can be independent of each other in terms of supporting weight. Therefore, the top, weight-contacting surface 32.1 of such sensors may not be circumferentially uniform or smooth. Likewise, the bearing contact points for assembly 152 can be discrete. Therefore, some embodiments of the present invention include a bottom platter 140 that is adapted and configured to transfer weight from bearing assembly 152 into the discrete sensors 32 regardless of the relative angular orientation of the discrete bearings 152 relative to the discrete weight sensors 32.

As shown, platter 140 in some embodiments is a relatively thin, sheet metal platter that permits the platter to locally bend in transferring load from a discrete bearing assembly 152 that is not located directly over a discrete transducer 32. However, yet other embodiments contemplate bottom platters fabricated from any kind of material (including plastics), and including those configurations that are substantially not flexible.

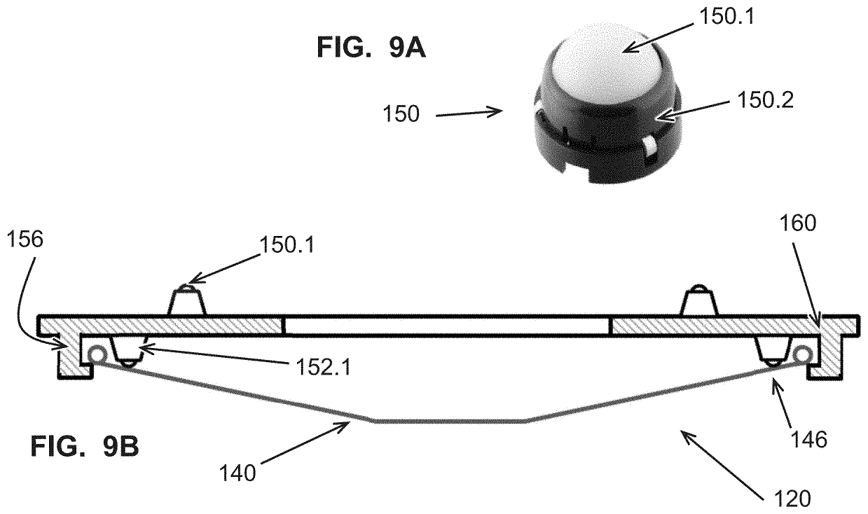

FIGS. 9A and 9B present other views of apparatus 120. FIG. 9A shows a type of roller bearing assembly useful in some embodiments of the present invention. A bearing assembly 150 preferably includes a ball bearing 150.1 that is contained within a holder 150.2. Referring to FIG. 9b, it can be seen that these assemblies 150 can be mounted with adhesives, ultrasonics, or bayonet or threaded connections to the top surface of platter 160. However, it is understood that the various bearing assemblies X50 and X42 shown herein contemplate any type of rotatable bearing, and also contemplate the use of non-rotatable, low friction bearing surfaces.

FIG. 9B presents one type of interconnection feature 156 in which the top platter 160 includes a downwardly depending wall and inwardly depending ledge that can retain a rolled peripheral lip of platter 140. In some embodiments, the inner connection features of the top and bottom platter are adapted and configured to permit a spring-type snap in of the bottom platter within the groove of the top platter 160. When installed as shown in FIG. 8, bottom platter 140 is substantially stationary relative to weight sensor 30, and top platter 160 (supporting the weight container 10b) is generally free to rotate on platter 140.

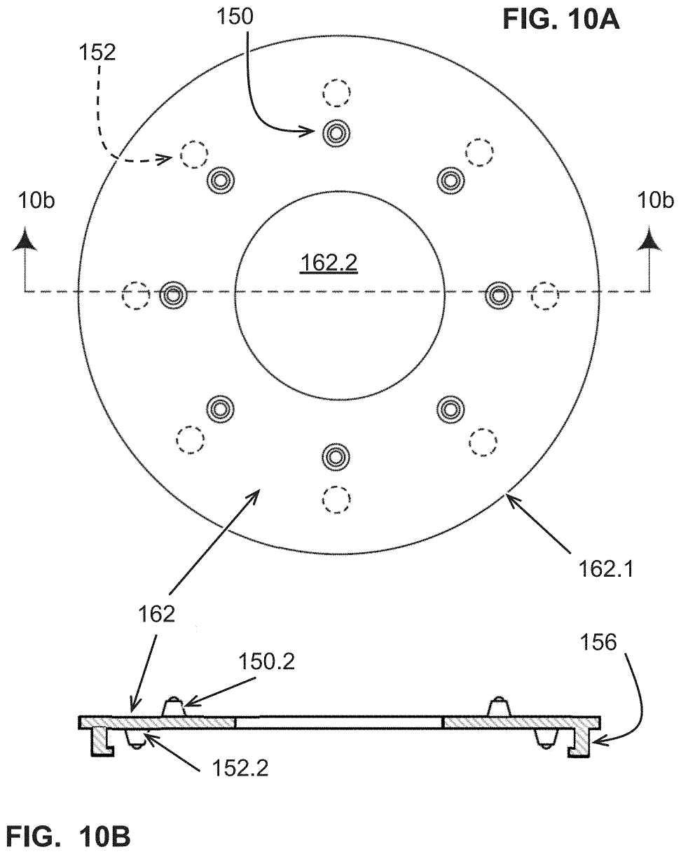

FIGS. 10A and 10B show top and side views, respectively, of top platter 160. It can be seen that a plurality of first bearing assemblies 150 are arranged circumferentially about the central aperture 162.2 of body 62, and preferably equally spaced apart. A second set of bearing assemblies 152 are arranged on the underside of platter 160. Referring to FIG. 10B, it can be seen that the weight of the beverage containing bearing down on the top ring of bearings 150 is transferred radially outward a short distance within body 162 to bottom bearing assemblies 152. Although what has been shown and described are a plurality of top bearings that are in substantial alignment with an equal plurality of bottom bearings, it is understood that yet other embodiments of the present invention contemplate different quantities of bearings on the top as to compared to the bottom, and further in which the angular placement about the platter body are not coincident.

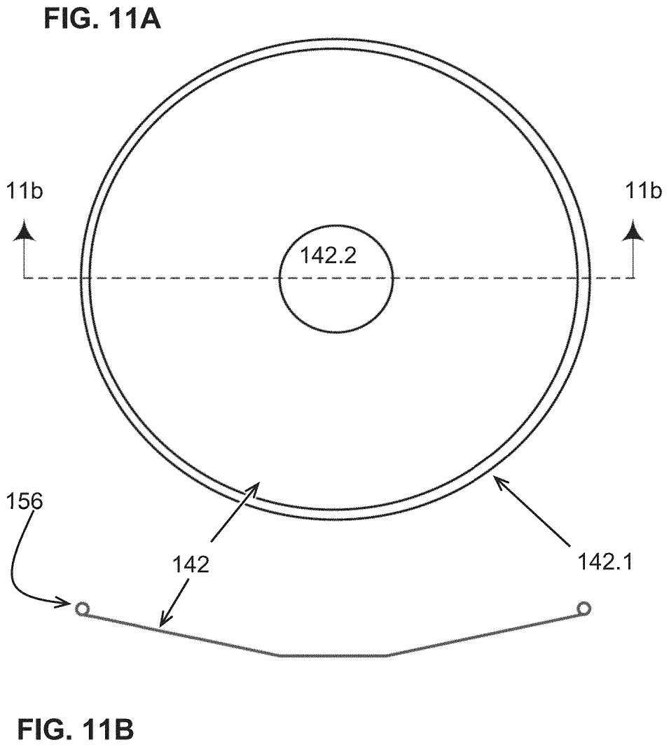

FIGS. 11A and 11B show top and side views of the bottom platter 140. It can be seen that the rolled lip 156 extends substantially around the entire circumference of body 142. Further, body 142 includes in some embodiments an upwardly concave surface (referring to FIG. 11B) that includes a flattened plateau 142.2 in the center. It is understood that in any of the embodiments shown herein, the platters may have a central aperture for avoiding contact with the container. In some embodiments, such as a flexible platter 140, the central portion of the platter may be intact tact as a way of preserving a degree in stiffness in the overall shape.

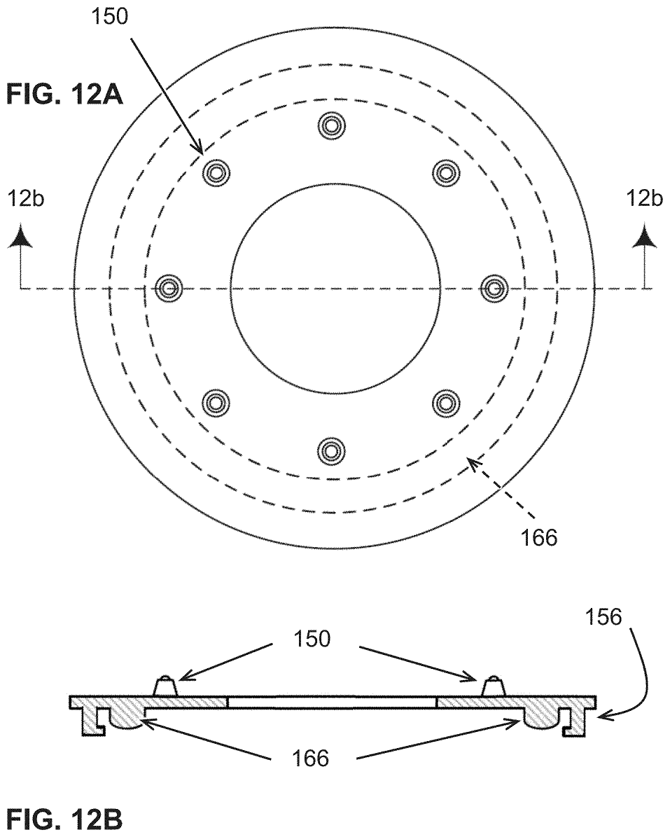

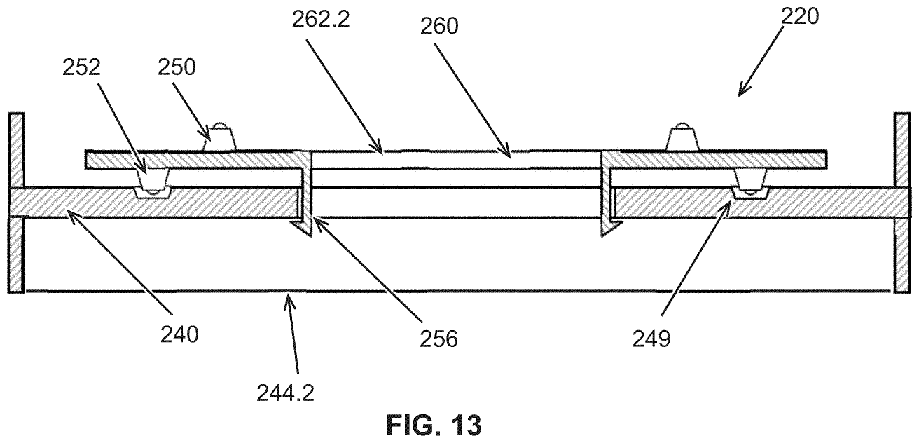

FIGS. 12A and 12B show another version of platter 160 similar to that shown in FIGS. 10A and 10B, except including a circumferential transducer contacting surface 166 that does not include a rotatable bearing, but is instead preferably a smoothly shaped, integral portion of the body 162. It is understood that bearing surfaces in any of the embodiments shown herein do not necessarily include rotatable bearings, but can also include smooth, low friction surfaces that provide minimal resistance to relative rotational movement.

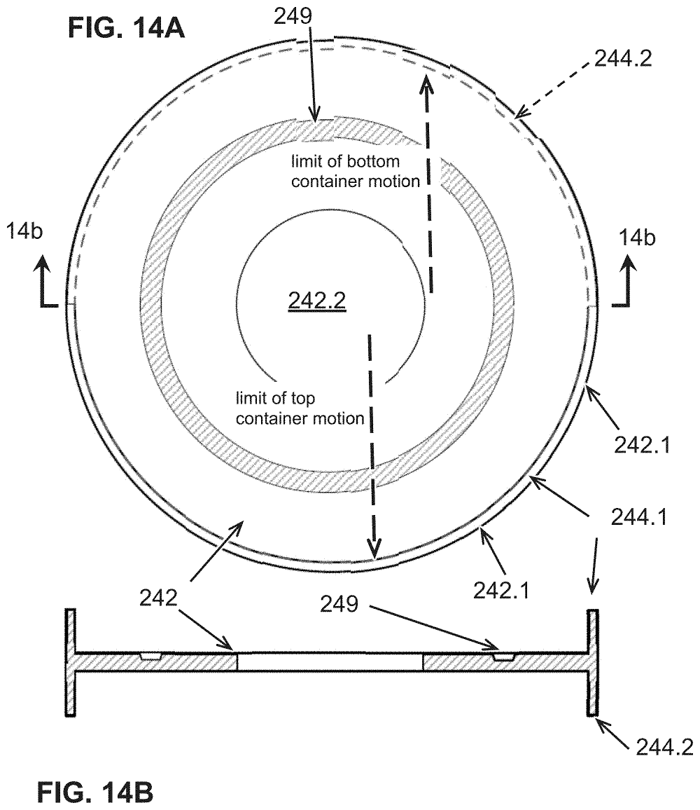

FIGS. 13 and 14 depict various aspects of a container agitation assembly 220 according to another embodiment of the present invention. FIG. 13 shows a cutaway side elevational view of the apparatus 220 shown in FIG. 3 at the bottom of beverage container 10d. In some embodiments, container agitator 220 can interface with a beverage container that is not also supported by a weight sensor (which is true for all of the container agitators X20 shown herein). Likewise, any of the container agitators X20 shown herein include apparatus and methods also useful for agitation of beverage containers that are supported by a weight sensor.

The top platter 260 is similar to the platter 160 shown in FIG. 11B. One difference between agitator 120 and agitator 220 would be the location of the interplatter connection features X56. Referring to FIG. 13, it can be seen that the interplatter connection 256 is provided at the outer periphery of the central apertures 262.2 and 242.2. In one embodiment, platter 262 includes a plurality of hooks that hook around the outer diameter of the central aperture 242.2. Preferably, these interconnections are located at discrete locations, and made sufficiently flexible such that platter 260 can be snapped into place on top of platter 240. It is understood that the interconnection features 256 shown in FIG. 13 could be of any other type, including hooks that extend upwardly from the outer diameter of the bottom aperture 242.2. It is understood that in many embodiments the interconnection features X56 do not inhibit rotation of one platter relative to the other platter, but do limit relative lateral movement and relative separation of the platters. Still further embodiments contemplate platters that are not interconnected to one another.

FIG. 13 shows an arrangement of top bearing assemblies 250 and bottom bearing assemblies 252 located on opposite sides of the body 262 of platter 260. Similar to that arrangement shown for container agitator 120, the top rotatable bearings 250.1 are in rotating contact with a surface of the container, and the lower rotatable bearings 242.1 are in bearing contact with a groove 249 of platter 240. It is understood that groove 249 can be of any shape. As shown, the groove is oversized relative to the rotatable bearing 252.1, such that a small amount of lateral movement is permitted between the top and bottom platters (consistent with the limitations on range of motion imposed by interconnection 256).

Considering FIGS. 3 and 13, it can be seen that the top platter 260 can be rotated independently of (and therefore relative to) both bottom plate 240 and the beverage container 10 supported by bearing assemblies 250. In this manner, the rotational movement of top platter 260 is unconstrained by either the beverage container or the bottom platter, and is instead free to rotate. In those embodiments in which the top platter X60 is rotationally “floating,” it is thought that the manual rotation of the beverage container by the operator will be easier, and help take into account irregularities in the surface of the supported beverage container, or damage or bending to either of the platters X60 or X40, or other installation anomalies. For example, if the bearing interface between assemblies 250 and the supported beverage container is binding in a particular location, the manual rotation by the operator will occur at the lower bearing assemblies 252 relative to platter 240. Likewise, if lower bearing assemblies 252 are binding for any reason, then the relative rotation may occur between the top bearing assemblies 250 and the supportive container.

However, it is understood that even though such “floating” top platters are shown herein for container agitators X20, the present invention also contemplates those embodiments in which any of the container agitators X20 include a single bearing interface between either one of the platters and a container (top or bottom), or between the platters themselves. Further, as discussed relative to embodiment 120, the bearing interfaces need not include rotatable bearings, but can further include smooth, low friction surfaces on one or more sides of each platter, and further between the platters and the beverage containers (such as between the spring clips 44.3 and the rolled edges 12.1 shown in FIG. 4).

FIGS. 14A and 14B depict various features of bottom platter 240. It can be seen that the body 242 includes a central aperture 242.2 which is useful for preventing interference with container features. Further, the bearing contact surface 249 is shown as a groove extending circumferentially within body 242.

FIGS. 14A and 14B further show a top means 264 for limiting lateral movement of assembly 220 relative to the container or sensor, and also bottom means 244 for limiting lateral movement of assembly 220 relative to a bottom container (not shown in FIG. 3). In some embodiments, lower means 244 for limiting lateral movement includes a downwardly extending wall 244.2 that extends less than one hundred and eighty degrees around the circumference of peripheral ledge 242.1. Likewise, the means 244 for limiting lateral movement includes an upwardly extending wall 244.1 that extends one hundred and eighty degrees or less around the perimeter 242.1. As seen in FIG. 14A, it can be seen that on the outermost lateral portions (next to the drawing indicators 14b) that the upwardly extending wall 244.1 ends, and the downwardly extending wall 244.2 begins. The downwardly extending wall 244.2 is shown in dotted lines in the upper half of FIG. 14A, and the upwardly extending wall 244.1 is shown in the bottom half of FIG. 14A. In the cross sectional view, both the bottom and top walls can be seen. Referring to FIG. 13, the bottom of the downwardly extending wall 244.2 can be seen extending from right to left. What is shown and described relative to FIGS. 13 and 14 is a platter that has a “C” shape on top, and a “C” shape on the bottom. The upwardly and downwardly depending walls are preferably laterally opposite of one another, and preferably located on alternate top and bottom sides.

The effect of these open “C” shapes is indicated by the dashed arrows and text on FIG. 14A. For example, if agitator 220 is placed on top of a container, the sliding limit of the bottom container is established by the bottom “C” wall 244.2, as shown by the dashed line. Likewise, if a beverage container is placed on top of assembly 220, the limit of the sliding motion of that top container relative to the agitator 220 is limited by contact with the inside of the top wall 244.1, as indicated by the dashed arrow. With this opposite and alternate arrangement of open C shapes, the placement of a top container on top of a platter that is already located on the top of a bottom container will not push the agitator 220 off of the bottom container. To the contrary, the sliding of a top container onto an agitator 220 will be unable to move the agitator 220 relative to the bottom container because of interference between the bottom container and the downwardly depending wall.

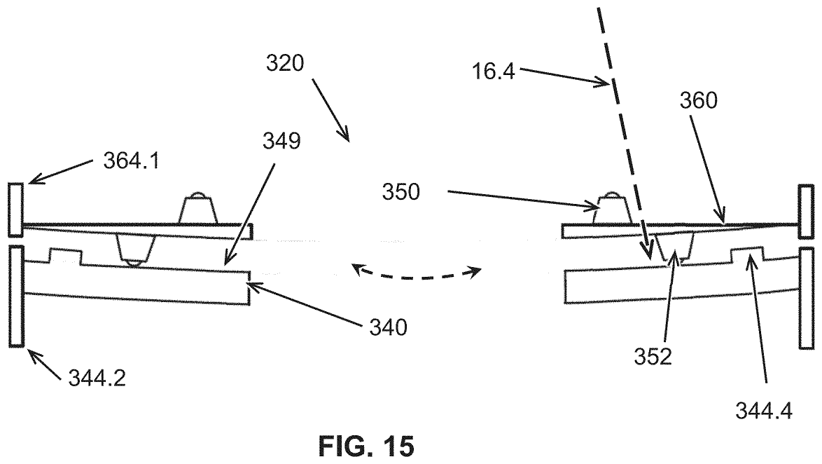

FIG. 15 shows a cutaway representation of a beverage container agitator 320 according to another embodiment of the present invention. Container agitator 320 includes a top platter 360 that is similar to top platters X60 described herein. A top set of bearing assemblies 350 are attached to a surface of body 362, with the rotatable bearings 350.1 preferably coming into contact with the bottom of a top beverage container or weight sensor.

Bottom platter 340 is different than the platters described herein, having a bearing contact surface 349 that is adapted and configured to permit a rocking motion of the top container relative to the bottom container. This rocking motion is indicated by the central dashed arrows of FIG. 15, and also in the directional arrows shown on beverage container 10c in FIG. 3. Surface 349 in some embodiments is a semispherical surface established by a radius 16.4 that preferably extends from the surface 349 to a point proximate to the top container. As shown in FIG. 3, the rotational center is established at about the center of the top surface of container 10c. However, it is also contemplated that this rocking axis can be established at various other geometric features of the top beverage container, including as one example a centroid 16.2 of the internal volume (referring to FIG. 1).

Referring again to FIG. 15, it can be seen that the operator can rock the top container relative to the bottom platter 340. This rocking motion may be advantageous for inducing agitation within the beverage. Referring to FIG. 15, the rocking motion can be laterally (right to left), fore and aft (in and out of the plane) of FIG. 15 or any combination thereof. Further, in some embodiments the surface 349 and the bearings 352 are adapted and configured to also permit rotational motion (about central axis 16.3) as noted in other embodiments.

FIG. 15 also shows that the top and bottom platters include means 364 and 344, respectively, for limiting lateral movement of the container relative to the platter. Top platter 360 includes an upwardly extending wall 364.1, and bottom platter 340 includes a downwardly extending wall 344.2. These walls can be C-shaped (as discussed relative to platter 220) or can be of any other circumferential extent. Further, bottom platter 340 includes an abutment 344.4 for limiting the rocking motion of the top platter 360 relative to the bottom platter 340.

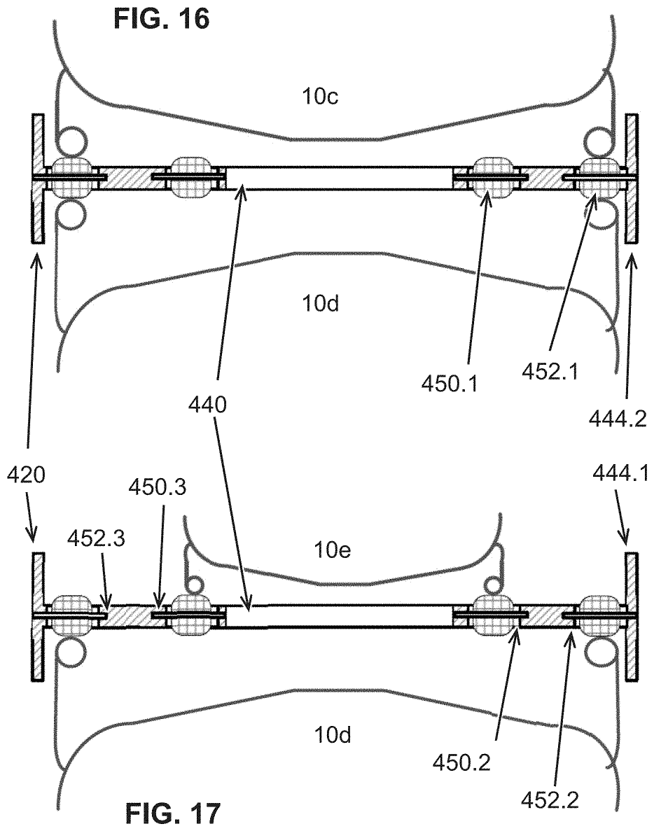

FIGS. 16 and 17 show multiple applications of a container agitator 420 according to another embodiment of the present invention. Agitator 420 in some embodiments includes a single platter 440 with one or more sets of bearing assemblies that are adapted and configured to support multiple sizes of beverage containers. Platter 420 includes a first plurality of bearing assemblies 450 arranged circumferentially about a central aperture 442.2. Preferably, a second assembly of bearings 452 is shown spaced radially outward from the first set of bearings 450. As shown and described, the arrangement of bearing sets 450 and 452 are preferably equally spaced apart circumferentially (such as those shown in FIG. 10A). However, various other embodiments of the present invention contemplate any circumferential or radial pattern of bearing sets mounted to platter 440.

In some embodiments, the inner and outer bearing sets 450 and 452, respectively, each include a plurality of cylindrical, rotatable bearings 450.1 or 452.1. These bearings are located within corresponding open pockets 450.2 and 452.2 of platter 440, respectively, such that the top and bottom surfaces of the rollers extend beyond the top or bottom surfaces of the body of the platter. Preferably, the bearing holders provide clearance for free rotation of the roller bearing contained therein. Further, each bearing is rotatably mounted to the body 442 of platter 440 by an axle 450.3 or 452.3, respectively.

As shown in FIG. 16, a container agitator 420 is located between two beverage containers 10c and 10d, each container being of roughly equivalent size. The outermost set of bearing assemblies 452 contact both the top and bottom containers. As shown, agitator 420 is fully floating, and can rotate independently of containers 10c and 10d. However, yet other embodiments of the present invention contemplate bearing assemblies 452 (or 450) in which the rollers are contained within a closed pocket 452.2 (or 450.2), such that there is rotating contact only on one side of platter 440 (in which embodiment platter 440 is no longer fully floating).

FIG. 17 shows another application of agitator 420. A second top container 10e of reduced size can be placed on the innermost set of bearing assemblies 450.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. An apparatus for supporting a beverage container, comprising:
a weight sensor for measuring the weight of a beverage container, wherein the beverage container is symmetrical about an axis;
a top platter having a top surface adapted and configured for supporting said weight sensor, and a bottom surface; and
a bottom platter rotatably supporting said top platter for rotation of the beverage container about the axis, said bottom platter including means for coupling said bottom platter to the top of a beverage container.

2. The apparatus of claim 1 wherein the top of the beverage container includes a rolled lip, and said coupling means is a spring clip that snaps onto the lip.

3. The apparatus of claim 1 wherein the top of the beverage container includes a circumferential top edge, and said coupling means is a skirt that extends on top of the edge and around at least a portion of the perimeter of the top edge.

4. (canceled)

5. The apparatus of claim 1 wherein said top platter includes a central aperture configured to provide clearance from the bottom of the beverage container, and said bottom platter includes a central aperture configured to provide clearance from the top of the beverage container.

6. The apparatus of claim 1 which further comprises a plurality of separate bearings located between said top platter and said bottom platter and circumferentially spaced apart from one another.

7-14. (canceled)

15. The apparatus of claim 1 wherein said top platter and said bottom platter are configured to be loosely coupled together to prevent their separation from one another.

16. An apparatus for supporting a beverage container, comprising:
a weight sensor assembly for measuring the weight of a beverage container, wherein the beverage container has a longitudinal axis, said assembly including a plurality of measurement stations circumferentially spaced apart;
a first plurality of rotatable bearings; and
a first platter having a top surface adapted and configured for supporting the bottom of the beverage container with the plurality of rotatable bearings, and a bottom surface, the bottom surface being adapted and configured to transfer the weight of the beverage container to the measurement stations.

17. The apparatus of claim 16 wherein the bottom surface transfers weight to the measurement stations with an annular region having a convex shape.

18. The apparatus of claim 16 which further comprises a second plurality of rotatable bearings on the bottom surface, wherein said first platter can rotate relative to the beverage container and can rotate relative to said weight sensor assembly.

19. (canceled)

20. The apparatus of claim 16 which further comprises a flexible second platter located between said top platter and said weight sensor assembly.

21. (canceled)

22. The apparatus of claim 16 wherein each measurement station includes a separate load sensor.

23. (canceled)

24. The apparatus of claim 16 wherein the bottom of the beverage container includes a rolled lip, and the top platter has an outer diameter less inner diameter of the rolled lip.

25. An apparatus for stacking of beverage containers, comprising:
a top platter having a top surface adapted and configured for contacting the bottom of a top beverage container and supporting the weight of the top beverage container, the top beverage container having a longitudinal axis, and a bottom surface;
a bottom platter having a periphery and rotatably supporting the bottom of said top platter for rotation of the top beverage container about the axis, said bottom platter including a bottom wall extending along at least a portion of the periphery for mounting said bottom platter to the top of a bottom beverage container; and
a plurality of rotatable bearings located between the bottom of said top platter and the top of said bottom platter, said plurality of bearings transferring the weight from said top platter to said bottom platter.

26. The apparatus of claim 25 wherein said bottom platter including a top wall extending upward along a least a portion of the periphery for limiting the lateral movement of the top beverage container when the top beverage container is located on the apparatus.

27. The apparatus of claim 25 wherein said top platter supports a first beverage container and said bottom platter is coupled to the top of a second beverage container, and the first beverage container has an empty volume greater than the empty volume of the second beverage container.

28. The apparatus of claim 25 wherein said bottom platter includes a recessed circular path adapted and configured to receive therein said plurality of rotatable bearings.

29-30. (canceled)

31. An apparatus for stacking of beverage containers, comprising:
a top platter having a top surface adapted and configured for contacting the bottom of a top beverage container and supporting the weight of the top beverage container, and a bottom surface, the top beverage container having a longitudinal axis;
a bottom platter having a periphery and a bearing surface for rotatably supporting the bottom of said top platter, said bottom platter including a bottom wall extending along at least a portion of the periphery for mounting said bottom platter to the top of a bottom beverage container; and
a first plurality of rotatable bearings located between the bottom of said top platter and the bearing surface of said bottom platter, said first plurality of bearings transferring the weight from said top platter to said bottom platter;
wherein the shape of the bearing surface is adapted and configured to permit rotation of the top beverage container relative to the bottom beverage container along a rotational axis that is at least partly orthogonal to the longitudinal axis.

32. The apparatus of claim 31 wherein the top beverage container having a bottom edge adapted and configured for supporting the top beverage container from a floor, and an internal volume, the internal volume having a centroid, and at least a portion of the bearing surface having a radius of curvature greater than the distance from the bottom edge to the centroid.

33. The apparatus of claim 31 wherein the top beverage container having a topmost edge and a bottommost edge, and at least a portion of the bearing surface having a radius of curvature greater than about half of the distance from the topmost edge to the bottommost edge.

34. An apparatus for stacking of beverage containers, comprising:
a top platter having a top surface the top beverage container having a longitudinal axis, and a bottom surface;
a platter assembly adapted and configured for contacting the bottom of a top beverage container and the top of a bottom beverage container and for supporting the weight of the top beverage container, said platter having a periphery and means for mounting said platter to the top of a bottom beverage container and means for limiting the lateral movement of the top beverage container when the top beverage container is located on said platter; and
a first plurality of bearings spaced circumferentially around said platter and each at a location adapted and configured for contact with the top of said bottom beverage container and for transferring the weight of the top beverage container to the bottom beverage container.

35. The apparatus of claim 34 wherein each location is adapted and configured for contact with the top beverage container and for transferring the weight of the top beverage container to first plurality of bearings.

36. The apparatus of claim 34 which further comprises a second plurality of bearings spaced circumferentially around said platter and each at a location adapted and configured for contact with the bottom of said top beverage container and for transferring the weight of the top beverage container to said platter, the locations of said second plurality of bearings being radially spaced apart from the locations of said first plurality of bearings.

37. The apparatus of claim 34 wherein said mounting means includes a bottom wall extending downward along at least a portion of the periphery.

38. (canceled)

39. The apparatus of claim 34 wherein said limiting means includes a top wall extending upward along a least a portion of the periphery.

40. (canceled)

41. The apparatus of claim 34 wherein each of said first plurality of bearings are adapted and configured to rotate about a single axis.

42. The apparatus of claim 34 wherein each of said first plurality of bearings are adapted and configured to rotate about two axes.
